(19) United States
(12) Patent Application Publication
(10) Pub. No.: US 2016/0380300 A1
(43) Pub. Date: Dec. 29, 2016

(54) SECONDARY BATTERY

(71) Applicant: SANYO Electric Co., Ltd., Osaka (JP)

(72) Inventors: Eiji Okutani, Hyogo (JP); Shinichirou Yoshida, Hyogo (JP); Takuya Yamawaki, Hyogo (JP)

(73) Assignee: SANYO Electric Co., Ltd., Osaka (JP)

(21) Appl. No.: 15/194,966

(22) Filed: Jun. 28, 2016

(30) Foreign Application Priority Data
Jun. 29, 2015 (JP) 2015-129431

(51) Int. Cl. H01M 10/04; H01M 4/04; H01M 2/02

(52) U.S. Cl. CPC H01M 10/0431; H01M 2/0237; H01M 4/04; H01M 10/052

(57) ABSTRACT

A wound electrode body includes a negative electrode core body exposed portion on one of the end portions of the wound electrode body in a winding axis direction, which is layered by being wound. A core body connection of a negative electrode collector is disposed on one of the outer surfaces of the layered negative electrode core body exposed portion, and a negative electrode collector receiving component is disposed on the other one of the outer surfaces. Furthermore, tapes are each disposed between the core body connection and the negative electrode core body exposed portion and between the negative electrode collector receiving component and the negative electrode core body exposed portion. Each tape includes a base material layer, and an adhesion layer containing a coloring agent.

### CROSS REFERENCE TO RELATED APPLICATIONS

The present invention application claims priority to Japanese Patent Application No. 2015-129431 filed in the Japan Patent Office on Jun. 29, 2015, the entire contents of which are incorporated herein by reference.

### BACKGROUND OF THE INVENTION

Field of the Invention

The present disclosure relates to a secondary battery.

Description of Related Art

Secondary batteries such as nonaqueous electrolyte secondary batteries, a representative example of which is a lithium ion secondary battery, me used in hybrid vehicles, electric vehicles, large power storage systems, and the like.

A nonaqueous electrolyte secondary battery includes an electrode body in which positive electrode plates that each include a positive electrode core body having a positive electrode active material mixture layer thereon and negative electrode plates that each include a negative electrode core body having a negative electrode active material mixture layer thereon are stacked while having separators interposed in between. Furthermore, a positive electrode collector that is electrically connected to a positive electrode terminal is connected to positive electrode core body exposed portions, and a negative electrode collector that is electrically connected to a negative electrode terminal is connected to negative electrode core body exposed portions.

In high capacity nonaqueous electrolyte secondary batteries in particular, since the areas of the positive electrode plates and the areas of the negative electrode plates need to be large, the number of stacked electrode plates are extremely large. Furthermore, in secondary batteries that are required to have high output characteristics, a large number of stacked core body exposed portions and the collector needs to be connected to each other. In such a case, a large energy is required to connect the stacked core body exposed portions and the connector to each other. Accordingly, when connecting the stacked core body exposed portions and the collector to each other, disadvantageously, melted metal particles may scatter.

In order to overcome the problem described above, Japanese Published Unexamined Patent Application No. 2009-32640 (Patent Document 1), proposes to dispose an insulation sealing material between a collector and core body exposed portions and at a periphery of a connection between the collector and the core body exposed portions.

### BRIEF SUMMARY OF THE INVENTION

When the tape is disposed near a portion between the collector and the core body exposed portions and where the collector and the core body exposed portions are to be connected to each other, the tape may be disadvantageously disposed at a position that is displaced from the predetermined position. Furthermore, when the disposed tape is displaced on the side at which the collector and the core body exposed portions are to be connected to each other, the tape may obstruct the connection between the collector and the core body exposed portions and the quality of the connection may be disadvantageously lowered.

An object of the present disclosure is to overcome the above problems.

According to an aspect of the present disclosure, a secondary battery includes a positive electrode plate in which a positive electrode active material mixture layer is formed on a positive electrode core body, a negative electrode plate in which a negative electrode active material mixture layer is formed on a negative electrode core body, an electrode body that includes the positive electrode plate and the negative electrode plate, an outer package that includes an opening and that houses the electrode body, a sealing plate that seals the opening, a core body exposed portion included in the electrode body, the core body exposed portion exposing the positive electrode core body or the negative electrode core body, a collector connected to the core body exposed portion, and a tape disposed between the collector and the core body exposed portion and at a periphery of a connection between the collector and the core body exposed portion, the tape including a base material layer and an adhesion layer provided on one side of the base material layer, the adhesion layer being adhered to at least either one of the collector and the core body exposed portion and containing a coloring agent.

According to the configuration described above, since the tape is disposed between the collector and the core body exposed portion and at the periphery of the connection between the collector and the core body exposed portion, scattering of the melted metal particles can be prevented. With the above, having damage to the electrode body been prevented or having internal short circuit been prevented, the secondary battery becomes highly reliable. Furthermore, the adhesion layer of the tape contains a coloring agent. Accordingly, since the position of the tape can be recognized more accurately and the tape can be accurately adhered to the predetermined position, a secondary battery in which the quality of the connection between the collector and the core body exposed portion is extremely high and in which reliability is high can be obtained. Furthermore, since the connection process can be stopped when the adhered position of the tape is displaced from the predetermined position, defective products can be prevented from being produced.

Note that by containing the coloring agent in the adhesion layer, the adhesion layer that does not contain any coloring agent can be colored. Desirably, the color agent is a coloring agent that does not adversely affect the property of the secondary battery even if in contact with the electrolyte.

Desirably, the coloring agent is a carbon material. For example, carbon particles, such as graphite or amorphous carbon, may be contained in the adhesion layer.

Desirably, the base material layer is formed of resin. Furthermore, the main component of the base material layer is, desirably, polypropylene, polyimide, polyphenylene sulfide, polyethylene, polyester, or polyethylenenaphthalate. The main component of the base material layer is to occupy the largest volume ratio among the volume ratios of the components of the base material layer.

Desirably, the adhesion layer becomes adhesive at normal temperature (25° C.). Desirably, the main component of the adhesion layer is a rubber adhesive, an acrylic adhesive, a polyethylene adhesive, or the like. The main component of the adhesion layer is to occupy the largest volume ratio among volume ratios of the components of the adhesion layer except for the volume ratio of the coloring agent. Note that the adhesion layer may be an adhesion layer with a heat welding property.

Desirably, the electrode body is a flat wound electrode body in which the positive electrode plate and the negative electrode plate having a separator interposed therebetween are wound. the wound electrode body includes a wound positive electrode core body exposed portion in a first edge portion and a wound negative electrode core body exposed portion in a second edge portion, and the core body exposed portion is the positive electrode core body exposed portion or the negative electrode core body exposed portion.

Desirably, the collector and the core body exposed portion are connected by resistance welding, and the base material layer is an electric insulation base material layer.

According to another aspect of the present disclosure, a secondary battery includes a positive electrode plate in which a positive electrode active material mixture layer is formed on a positive electrode core body, a negative electrode plate in which a negative electrode active material mixture layer is formed on a negative electrode core body, an electrode body that includes the positive electrode plate and the negative electrode plate, an outer package that includes an opening and that houses the electrode body, a sealing plate that seals the opening, a core body exposed portion included in the electrode body, the core body exposed portion exposing the positive electrode core body or the negative electrode core body, a collector connected to the core body exposed portion, a tape disposed between the collector and the core body exposed portion and at as periphery of a connection between the collector and the core body exposed portion, the tape including a first base material layer, a second base material layer, a first adhesion layer, and a second adhesion layer, in which the first adhesion layer is disposed between the first base material layer and the second base material layer and adheres the first base material layer and the second base material layer to each other, the second adhesion layer is disposed on a surface of the second base material layer on an opposite side with respect to a side on which the first adhesion layer is disposed, the second adhesion layer is adhered to at least one of the collector and the core body exposed portion, and the first adhesion layer contains a coloring agent.

According to the configuration of the secondary battery of the another mode of the present disclosure, since the tape is disposed between the collector and the core body exposed portion and at the periphery of the connection between the collector and the core body exposed portion, scattering of the melted metal particles can be prevented. With the above, having damage to the electrode body been prevented or having internal short circuit been prevented, the secondary battery becomes highly reliable. Furthermore, the adhesion layer of the tape contains a coloring agent. Accordingly, since the position of the tape can be recognized more accurately and the tape can be accurately adhered to the predetermined position, a secondary battery in which the quality of the connection between the collector and the core body exposed portion is extremely high and in which reliability is high can be obtained. Furthermore, since the connection process can be stopped when the adhered position of the tape is displaced from the predetermined position, defective products can be prevented from being produced.

Furthermore, in the secondary battery of the another mode of the present disclosure, the first adhesion layer disposed between the first base material layer and the second base material layer contains a coloring agent. Accordingly, the adhesion layer containing the coloring agent can be reliably prevented from being partially peeled off from the base material layer. Accordingly, the secondary battery becomes more reliable.

Desirably, the coloring agent is a carbon material. For example, carbon particles, such as graphite or amorphous carbon, may be contained in the adhesion layer.

Desirably, the first base material layer and the second base material layer are formed of resin. Furthermore, the main component of the first base material layer and that of the second base material layer are, desirably, polypropylene, polyimide, polyphenylene sulfide, polyethylene, polyester, or polyethylenenaphthalate. The main component of the first base material layer and that of the second base material layer are to occupy the largest volume ratio among the volume ratios of the components of the first base material layer and the volume ratios of the second base material layer, respectively.

Desirably, the first adhesion layer and the second adhesion layer become adhesive at normal temperature (25° C.). Desirably, the main component of the first adhesion layer and that of the second adhesion layer are a rubber adhesive, an acrylic adhesive, a polyethylene adhesive, or the like. The main component of the first adhesion layer and that of the second adhesion layer are to occupy the largest volume ratio among the volume ratios of the components of the first adhesion layer and the volume ratios of the second adhesion layer, respectively, except for the whim ratio of the coloring agent. Note that the adhesion layer may be an adhesion layer with a heat welding property.

### BRIEF DESCRIPTION OF THE SEVERAL VIEWS OF THE DRAWINGS

FIG. 1A is a cross-sectional, view of a square secondary battery according to an exemplary embodiment, and FIG. 1B is a cross-sectional view taken along line IB-IB in FIG. 1A;

FIG. 2 is a cross-sectional view of a portion near a connection between negative electrode core body exposed portions and a core body connection of a negative electrode collector taken in a winding axis direction of a wound electrode body;

FIG. 3 is a cross-sectional view of the portion near the connection between the negative electrode core body exposed portions and the core body connection of the negative electrode collector taken in the winding axis direction of the wound electrode body, and illustrates a connection process;

FIG. 4 is a plan view the core body connection of the negative electrode collector on which a tape is adhered;

FIG. 5 is an enlarged cross-sectional view of a portion near the tape in the square secondary battery according to the exemplary embodiment;

FIG. 6 is an enlarged cross-sectional view of a portion near a tape in a square secondary battery according to a reference example;

FIG. 7 is an enlarged cross-sectional view of a portion near a tape in a square secondary battery according to a modification; and

FIG. 8 is an enlarged cross-sectional view of a portion near the tape in the square secondary battery according to the exemplary embodiment.

### DETAILED DESCRIPTION OF THE INVENTION

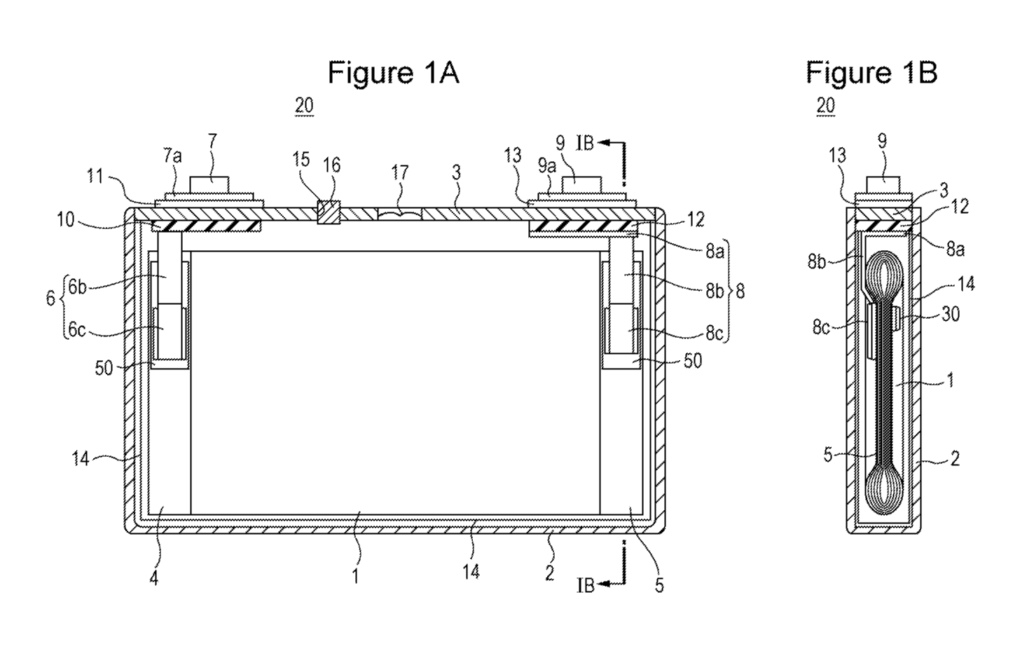

Hereinafter, an exemplary embodiment of the present disclosure will be described in detail with reference to the drawings. Note that the present disclosure is not limited to the following modes. Referring first to FIGS. 1A and 1B, a configuration of a square secondary battery 20 according to the exemplary embodiment will be described.

As illustrated in FIGS. 1A and 1B the square secondary battery 20 includes a square outer package 2 that has an opening on the upper side, and a sealing plate 3 that seals the opening. A battery case is constituted by the square outer package 2 and the sealing plate 3. The square outer package 2 and the sealing plate 3 are made of metal and, desirably, are made of aluminum or an aluminum alloy. A flat wound electrode body 1, in which a positive electrode plate and a negative electrode plate having a separator (each not shown) interposed therebetween are wound, is accommodated inside the square outer package 2 together with an electrolyte. The positive electrode plate is a member in which a positive electrode active material mixture layer including a positive electrode active material is formed on a metal positive electrode core body. A portion in which the positive electrode core body is exposed is formed in the longitudinal direction of the positive electrode plate. The negative electrode plate is a member in which a negative electrode active material mixture layer including a negative electrode active material is formed on a metal negative electrode core body. A portion in which the negative electrode core body is exposed is formed in the longitudinal direction of the negative electrode plate. Note that, desirably, the positive electrode core body is made of aluminum or an aluminum alloy and the negative electrode core body is made of copper or a copper alloy.

The wound electrode body includes, on one side thereof in the winding axis direction, a positive electrode core body exposed portion 4 in which no positive electrode active material mixture layer is formed and includes, on the other side thereof in the winding axis direction, a negative electrode core body exposed portion 5 in which no negative electrode active material mixture layer is formed. By being wound, the positive electrode core body exposed portion 4 forms layers of a plurality of positive electrode core body exposed portions 4. By being wound, the negative electrode core body exposed portion 5 forms layers of a plurality of negative electrode core body exposed portions 5. A positive electrode collector 6 is connected to the positive electrode core body exposed portions 4. A positive electrode terminal 7 is connected to the positive electrode collector 6. A negative electrode collector 8 is connected to the negative electrode core body exposed portions 5. A negative electrode terminal 9 connected to the negative electrode collector 8. Tapes 50 are each disposed between the positive electrode collector 6 and the positive electrode core body exposed portions 4 and between the negative electrode collector 8 and the negative electrode core body exposed portions 5.

The positive electrode terminal 7 includes a flange portion 7a disposed on the outer surface side of the sealing plate 3, and an insertion portion inserted in a through hole provided in the sealing plate 3. Furthermore, the negative electrode terminal 9 includes a flange portion 9a disposed on the outer surface side of the sealing plate 3, and an insertion portion inserted in a through hole provided in the sealing plate 3.

In the positive electrode core body exposed portions 4, a positive electrode collector receiving component is disposed on the surface on the opposite side with respect to the side on which the positive electrode collector 6 is disposed. Furthermore, in the negative electrode core body exposed portions 5, a negative electrode collector receiving component 30 is disposed on the surface on the opposite side with respect to the side on which the negative electrode collector 8 is disposed. Note that the positive electrode collector receiving component and the negative electrode collector receiving component 30 are not essential components and can be omitted.

The positive electrode collector 6 includes a terminal connection connected to the positive electrode terminal 7, a lead portion 6b extending from the terminal connection towards the wound electrode body 1 side, and a core body connection 6c that is provided on the distal end side of the lead portion 6b and that is connected to the positive electrode core body exposed portions 4. Desirably, the positive electrode collector 6 is made of aluminum or an aluminum alloy. Furthermore, the thickness of the positive electrode collector 6 is desirably about 0.5 to 2 mm.

The negative electrode collector 8 includes a terminal connection 8a connected to the negative electrode terminal 9, a lead portion 8b extending from the terminal connection 8a towards the wound electrode body 1 side, and a core body connection 8c that is provided on the distal end side of the lead portion 8b and that is connected to the negative electrode core body exposed portions The negative electrode collector 8 is desirably made of copper or a copper alloy. Furthermore, the thickness of the negative electrode collector 8 is desirably about 0.5 to 2 mm.

The positive electrode terminal 7 and the positive electrode collector 6 are connected to the sealing plate 3 with an outer side insulating member 11 and an inner side insulating member 10, respectively, in between. The negative electrode terminal 9 and the negative electrode collector 8 are connected to the sealing plate 3 with an inner side insulating member 12 and an outer side insulating member 13, respectively, in between. Each of the inner side insulating members 10 and 12 is disposed between the sealing plate 3 and the corresponding terminal, and each of the outer side insulating members 11 and 13 is disposed between the sealing plate 3 and the corresponding collector. The wound electrode body 1 is accommodated inside the square outer package 2 while covered by an insulation sheet 14. The sealing plate 3 is connected by welding, such as laser welding, to an opening edge portion of the square outer package 2. The sealing plate 3 includes an electrolyte injection hole 15, and the electrolyte injection hole 15 is sealed with a sealing plug 16 after injection of the electrolyte. A gas discharge valve 17 is formed in the sealing plate 3 to discharge gas when the pressure inside the battery becomes equivalent to or higher than a predetermined value. Note that a current breaking mechanism that is activated and that cuts off a conductive path between the positive electrode plate and the positive electrode terminal 7 or a conductive path between the negative electrode plate and the negative electrode terminal 9 when the pressure inside the battery becomes equivalent to or higher than a predetermined value may be provided. When the current breaking mechanism is provided, the operation pressure of the current breaking mechanism is to be lower than the operation pressure of the gas discharge valve 17.

### Fabrication of Wound Electrode Body

A method for fabricating the wound electrode body 1 will be described next. Lithium cobalt oxide (LiCoO₂) serving as a positive electrode active material, and a positive electrode mixture including a conductive agent and a binding agent are coated on both surfaces of as rectangular, 15 μm thick aluminum foil serving as a positive electrode core body to form a positive electrode active material mixture layer. Subsequently, a positive electrode plate that includes, at an end portion thereof on one side in the short direction, a positive electrode core body exposed portion that has a predetermined width and that has no positive electrode active material mixture coated thereon is fabricated. Furthermore, a negative electrode mixture, serving as a negative electrode active material, including natural graphite powder and a binding agent is coated on both surfaces of a rectangular, 8 μm thick copper foil serving as a negative electrode core body to form a negative electrode active material mixture layer. Subsequently, a negative electrode plate that includes, at an end portion thereof on one side in the short direction, a negative electrode core body exposed portion that has a predetermined width and that has no negative electrode active material mixture coated thereon is fabricated.

The positive electrode plate and the negative electrode plate are offset with respect to each other such that the positive electrode core body exposed portion of the positive electrode plate and the negative electrode core body exposed portion of the negative electrode plate obtained with the method described above do not overlap with the active material mixture layers of the opposing electrodes. The positive electrode plate and the negative electrode plate are wound while having the porous separator made of polyethylene interposed therebetween, and are formed into a flat shape. With the above, a flat-shaped wound electrode body 1 including a positive electrode core body exposed portions 4 in which plurality of positive electrode core bodies are layered at one end portion, and a negative electrode core body exposed portions 5 in which a plurality of negative electrode core bodies are layered on the other end portion is obtained.

### Assembling Sealing Body

A method of attaching the positive electrode collector 6, the positive electrode terminal 7, the negative electrode collector 8, and the negative electrode terminal 9 to the sealing plate 3 will be described next with the method performed on the negative electrode side as an example. Note that the positive electrode side can be attached with the method that is the same as that of the left electrode side.

The outer side insulating member 13 is disposed on the battery outer side of the sealing plate 3, and the inner side insulating member 12 and the terminal connection 8a of the negative electrode collector 8 are disposed on the battery inner side of the sealing plate 3. The insertion portion of the negative electrode terminal 9 is inserted into through holes each formed in the outer side insulating member 13, the sealing plate 3, the inner side insulating. member 12, and the terminal connection 8a from the battery outer side, and the distal end side of the insertion portion is riveted. With the above, the negative electrode terminal 9, the outer side insulating member 13, the sealing plate 3, the inner side insulating member 12, and the terminal connection 8a are fixed in an integrated manner.

### Attaching Collector to Electrode Body

A method of attaching the positive electrode collector 6 and the negative electrode collector 8 to the wound electrode body 1 will be described next with the method performed on the negative electrode side as an example. Note that the positive electrode side can be attached with the same method as that of the left electrode side.

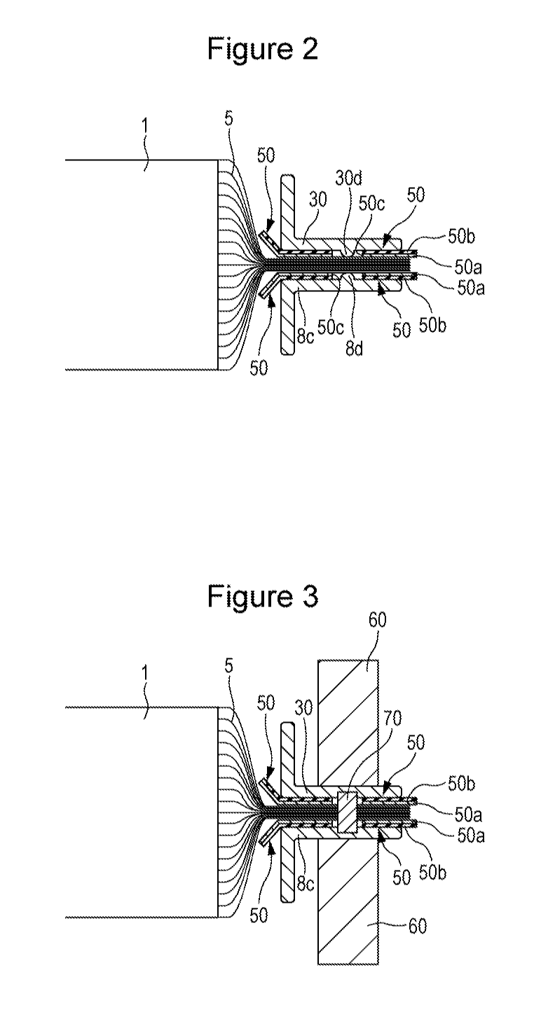

As illustrated in FIG. 2, the core body connection 8c of the negative electrode collector 8 is disposed on one of the outer surfaces of the layered negative electrode core body exposed portions 5, and the negative electrode collector receiving component 30 is disposed on the other one of the outer surfaces. In the above, tapes 50 are each disposed between the core body connection 8c and the negative electrode core body exposed portions 5 and between the negative electrode collector receiving component 30 and the negative electrode core body exposed portions 5. Each tape 50 includes a base material layer 50a, and an adhesion layer 50b formed on one side of the base material layer 50a. Furthermore, each tape 50 includes an opening 50c in a middle portion. The adhesion layer 50b of each tape 50 is adhered to the corresponding one of the core body connection 8c of the negative electrode collector 8 and the negative electrode collector receiving component 30.

A projection 8d is provided in a portion of the core body connection 8c that is to be connected to a negative electrode core body exposed portions 5, and a projection 30d is provided in a portion of the negative electrode collector receiving component 30 that is to be connected to a negative electrode core body exposed portions 5. The projection 8d and the projection 30d are provided at positions that correspond to the openings 50c provided in the tapes 50. By providing the projections 8d and 30d, resistance welding can be performed on the core body connection 8c, the negative electrode core body exposed portions 5, and the negative electrode collector receiving component 30 more efficiently. Note that the projections 8d and 30d are not essential configurations. For example, even without the projections 8d and 30d, resistance welding may be performed by having the core body connection 8c, the negative electrode core body exposed portions 5, and the negative electrode collector receiving component 30 come in contact with each other by pressing the core body connection 8c, the negative electrode core body exposed portions 5, and the negative electrode collector receiving component 30 firmly with a pair of resistance welding electrodes.

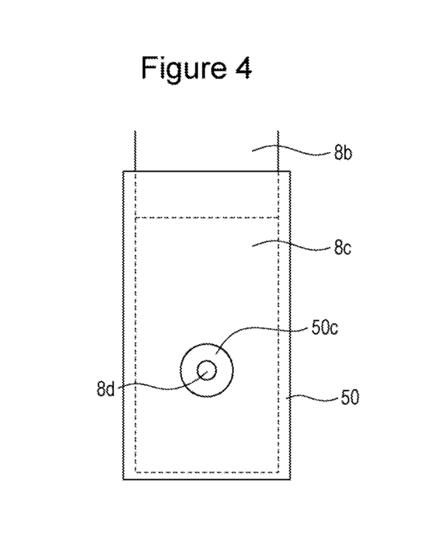

FIG. 4 is a plan view of the core body connection 8c on which the tape 50 has been adhered.

FIG. 3 is a diagram illustrating a connection process of the core body connection 8c, the negative electrode core body exposed portions 5, and the negative electrode collector receiving component 30. As illustrated in FIG. 3, by applying resistance welding current to a pair of resistance welding electrodes 60 while holding the core body connection 8c, the negative electrode core body exposed portions 5, and the negative electrode collector receiving component 30 with the pair of resistance welding electrodes 60, the core body connection 8c, the negative electrode core body exposed portions 5, and the negative electrode collector receiving component 30 are welded, and a weld 70 is formed.

In the square secondary battery 20, the tapes 50 are each disposed between the core body connection 8c and the negative electrode core body exposed portions 5 and between the negative electrode collector receiving component 30 and the negative electrode core body exposed portions 5. Accordingly, even if melted metal particles are created during welding, the tapes 50 captures the metal particles awl prevents the metal particles from scattering.

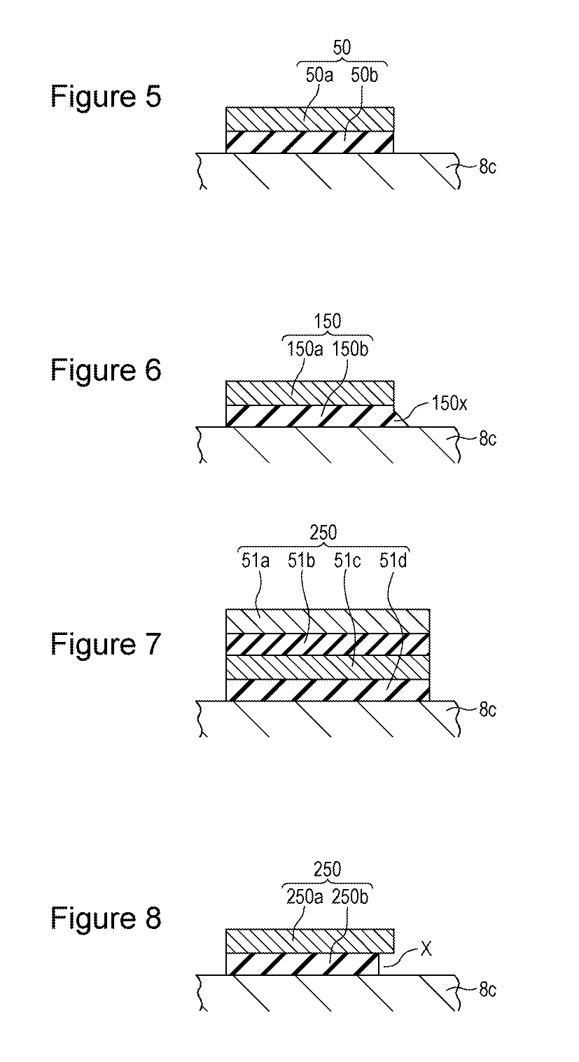

FIG. 5 is an enlarged cross-sectional view of the core body connection 8c of the negative electrode collector 8 of the square secondary battery 20 and the tape 50 taken along the thickness direction of the tape 50. As illustrated in FIG. 5, the tape 50 includes the base material layer 50a, and the adhesion layer 50b formed on one side of the base material layer 50a Furthermore, the adhesion layer 50b is adhered to the surface of the core body connection 8c of the negative electrode collector 8.

The tape 50 contains a carbon material and is colored by the carbon material. Accordingly, the displacement of the tape 50 during manufacturing of the battery can be detected by an optical sensor and an image processing device, and the like.

Furthermore, in the tape 50, carbon material is contained not in the base material layer 50a but in the adhesion layer 50b and, accordingly, the adhesion layer 50b is colored. Accordingly, the following excellent advantage exist.

FIG. 6 is an enlarged cross-sectional view of a portion of a square secondary battery according to a reference example corresponding to a portion of the square secondary battery in FIG. 5. A tape 150 includes a base material layer 150a, and an adhesion layer 150b formed on one side of the base material layer 150a Furthermore, the adhesion layer 150b is adhered to the surface of the core body connection 8c of the negative electrode collector 8. The tape 150 is cut into a predetermined shape from a base material with a large area, and an opening is formed at the middle thereof Accordingly, the end portion of the tape 150 is the portion where cutting has been performed. Typically, the adhesion layer 150b is softer than the base material layer 150a. Accordingly, as illustrated in FIG. 6, there may be a case in which the adhesion layer 150b slightly protrudes from the end portion of the base material layer 150a when performing cutting or when forming the opening. In such a case, even if the base material layer 150a contains a coloring agent, it will be difficult to detect the position of the adhesion layer 150b with an extremely high accuracy.

Conversely, as in the square secondary battery 20, by including a coloring agent in the adhesion layer 50b of the tape 50, the problem described above can be overcome.

### Modification

FIG. 7 is an enlarged cross-sectional view of a port on of a square secondary battery according to a modification corresponding to a portion of the square secondary battery in FIG. 5.

The tape 51 includes a first base material layer 51a, a second base material layer 51c, a first adhesion layer 51b, and a second adhesion layer 51d. The first adhesion layer 51b is disposed between the first base material layer 51a and the second base material layer 51c and adheres the first base material layer 51a and the second base material layer 51c to each other. The second adhesion layer 51d is disposed on the surface of the second base material layer 51c on the opposite side with respect to the side on which the first adhesion layer 51b is disposed. Furthermore, the second adhesion layer 51d is adhered to the core body connection 8c. Note that the first adhesion layer 51b contains a carbon material serving as a coloring agent. Accordingly, the displacement of the tape 51 during manufacturing of the battery can be detected at a higher accuracy by an optical sensor and an image processing device, and the like.

Furthermore, the configuration of the tape 51 has the following excellent advantage.

Typically, at a stage before the tape is adhered to the core body connection 8c or the like, the tape is stored with a peeling member, such as a film, adhered to the surface of the adhesion layer. Furthermore, the peeling member is peeled off from the adhesion layer to adhere the adhesion layer to the core body connection 8c or the like.

When the peeling member is peeled off from the adhesion layer, there may be a case in which a portion of the adhesion layer remains on the peeling member disadvantageously creating a portion where no adhesion layer exists in a portion of the base material layer. When such a tape 250 is used as illustrated in FIG. 8, a defective portion X in which no adhesion layer 250b is formed will exist in a portion of a base material layer 250a. In such a case, because of the presence of the defective portion X, it may be difficult to detect the displacement of the tape 250 with an extremely high accuracy.

Conversely, in the configuration described in FIG. 7, since the first adhesion layer 51b containing a carbon material is disposed between the first base material layer 51a and the second base material layer 51c, when the peeling member is peeled off from the tape 51, creation of a defective portion in the first adhesion layer 51b can be reliably prevented. Accordingly, displacement of the tape 51 can be detected with an extremely high accuracy.

Note that the second adhesion layer 51d does not have to contain a coloring agent. However, it is desirable that the second adhesion layer 51d includes a coloring agent and it is more desirable that the coloring agent is a carbon material.

### Others

Desirably, the base material layer is a member selected from polypropylene, polyimide, polyphenylene sulfide, polyethylene, polyester, polyethylenenaphthalate, and the like or is a mixture of the above. In particular, the base material layer is desirably, polypropylene, Furthermore, the base material layer may be transparent.

While the thickness of the base material layer is not limited to any thickness in particular, the thickness is desirably 20 μm to 100 μm.

Desirably, the adhesion layer becomes adhesive at normal temperature (25° C.). Furthermore, the adhesion layer may be an adhesion layer capable of heat welding.

Desirably, the adhesion layer is a member selected from a rubber adhesive, an acrylic adhesive, a polyethylene adhesive, and the like, or is a mixture of the above. Particularly, the adhesion layer is, desirably, a rubber adhesive.

While the thickness of the adhesion layer is not limited to any thickness in particular, the thickness is desirably 5 μm to 30 μm.

The amount of coloring agent contained in the adhesion layer is preferably 10% to 80%, more preferably, 25% to 75%, in volume with respect to the total volume of the adhesion layer.

Desirably, the coloring agent is a carbon material. Desirably, amorphous carbon, such as graphite or carbon black, is used as the carbon material. Furthermore, a particulate carbon material is desirably contained in the adhesion layer. Note that the color tone of the adhesion layer can be adjusted by changing the rate of the carbon material in the adhesion layer, the diameter of the particles of the carbon material, and the specific surface area of the carbon material.

The method of connecting the collector and the core body exposed portions to each other is not limited to resistance welding, and may be ultrasonic welding or welding using a projection of a high energy ray.

Note that when the collector and the core body exposed portions are connected to each other by resistance welding, desirably, the tape is provided with an electric insulation base material layer. With the above, the resistance welding current can be prevented from flowing into an unintended portion.

Note that the collector receiving component is not an essential component and can be omitted. Furthermore, in a case in which the collector receiving component is used, the tape does not have to be disposed between the collector receiving component and the core body exposed portions.

The electrode body may be a wound electrode body or may be a stacked electrode body in which a plurality of positive electrode plates and a plurality of negative electrode plates are stacked. Furthermore, the core body exposed portion that are connected to the collector may be simply stacked or may be layered by being wound.

The tape may be disposed between the collector and the core body exposed portions and at the periphery of the connection between the collector and the core body exposed portions. However, the tape is desirably disposed so as to surround 180° or more, more desirably, 270° or more, of the periphery of the connection between the collector and the core body exposed portions. Desirably, the tape is disposed so as to surround 360° of the periphery of the connection between the collector and the core body exposed portions.

In the square secondary battery 20, an example in which the adhesion layer of the tape is adhered to the collector has been given; however, the adhesion layer of the tape may be adhered to the core body exposed portions.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is clamed is:

1. A secondary battery, comprising: a positive electrode plate in which a positive electrode active material mixture layer is formed on a positive electrode core body;
a negative electrode plate in which a negative electrode active material mixture layer is formed on a negative electrode core body;
an electrode body that includes the positive electrode plate and the negative electrode plate;
an outer package that includes an opening and that houses the electrode body;
a sealing plate that seals the opening;
a core body exposed portion included in the electrode body, the core body exposed portion exposing the positive electrode core body or the negative electrode core body;
a collector connected to the core body exposed portion; and
a tape disposed between the collector and the core body exposed portion and at a periphery of a connection between the collector and the core body exposed portion, the tape including a base material layer and an adhesion layer provided on one side of the base material layer, the adhesion layer being adhered to at least either one of the collector and the core body exposed portion and containing a coloring agent.

2. The secondary battery according to claim 1, wherein the coloring agent is a carbon material.

3. The secondary battery according to claim 1 wherein
a main component of the base material layer is polypropylene, polyimide, polyphenylene sulfide, polyethylene, polyester, or polyethylenenaphthalate.

4. The secondary battery according to claim 1, wherein
a math component of the adhesion layer is a rubber adhesive, an acrylic adhesive, or a polyethylene adhesive.

5. The secondary battery according to claim 1, wherein
the electrode body is a flat wound electrode body in which the positive electrode plate and the negative electrode plate having a separator interposed therebetween are wound,
the wound electrode body includes a wound positive electrode core body exposed portion in as first end portion and a wound negative electrode core body exposed portion in a second end portion, and
the core body exposed portion is the positive electrode core body exposed portion or the negative electrode core body exposed portion.

6. A secondary battery, comprising:
a positive electrode plate in which a positive electrode active material mixture layer is formed on a positive electrode core body;
a negative electrode plate in which a negative electrode active material Mixture layer is formed on a negative electrode core body;
an electrode body that includes the positive electrode plate and the negative electrode plate;
an outer package that includes an opening and that houses the electrode body;
a sealing plate that seals the opening;
a core body exposed portion included in the electrode body, the core body exposed portion exposing the positive electrode core body or the negative electrode core body;
a collector connected to the core body exposed portion; and
a tape disposed between the collector and the core body exposed portion and at a periphery of a connection between the collector and the core body exposed portion, the tape including first base material layer, a second base material layer, a first adhesion layer, and a second adhesion layer, wherein
the first adhesion layer is disposed between the first base material layer and the second base material layer and adheres the first base material layer and the second base material layer to each other,
the second adhesion layer is disposed on a surface of the second base material layer on an opposite side with respect to a side on which the first adhesion layer is disposed,
the second adhesion layer is adhered to at least one of the collector and the core body exposed portion, and
the first adhesion layer contains a coloring agent.

7. The secondary battery according to claim 6, wherein
the coloring agent is a carbon material.

8. The secondary battery according to claim 6, wherein
a main component of the first base material layer is polypropylene, polyimide, polyphenylene sulfide, polyethylene, polyester, or polyethylenenaphthalate.

9. The secondary battery according to claim 6, wherein
a main component of the second base material layer is polypropylene, polyimide, polyphenylene sulfide, polyethylene, polyester, or polyethylenenaphthalate.

10. The secondary battery according to claim 6, wherein
a main component of the first adhesion layer is a rubber adhesive, an acrylic adhesive, or a polyethylene adhesive.

11. The secondary battery according to claim 6, wherein
a main component of the second adhesion layer is a rubber adhesive, an acrylic adhesive, or a polyethylene adhesive.
